(19) United States
(12) Patent Application Publication
(10) Pub. No.: US 2008/0038423 A1
(43) Pub. Date: Feb. 14, 2008

(54) Method And Device For Producing A Beverage

(76) Inventors: Keesjan Klant, Teufen (CH); Richard Amiel, Bemeck (CH)

Correspondence Address: MORRISS OBRYANT COMPAGNI, P.C., 734 EAST 200 SOUTH, SALT LAKE CITY, UT, 84102, US

(21) Appl. No.: 11/628,588

(22) PCT Filed: Jun. 3, 2005
(86) PCT No.: PCT/CH05/00312

§ 371 Date: Dec. 4, 2006

(30) Foreign Application Priority Data
Jun. 4, 2004 (CH) 937/04

(51) Int. Cl. A23L 2/00; A23L 1/48; A47J 31/44

(52) U.S. Cl. 426/431; 99/289 R

(57) ABSTRACT

With a method for manufacture of a ready-to-drink beverage by way of extraction of a solid-matter aroma carrier (19) by way of water, the aroma carrier (19) required for an individual consumption quantity is successively moved through an extraction region (25), a part quantity of the aroma carrier (19) present in the extraction region (25) is permeated with water, wherein the water absorbs aroma substances from the aroma carrier (19), and subsequently the aroma carrier (19) is separated from the extract (49). The method is characterized in that the aroma carrier (19) is forcibly conveyed with a conveyor device (21,43,53,55) along a conveyor route from A to B through the extraction region (25). A device for the forced conveying of the aroma carrier (19) for example has a conveyor worm, two conveyor belts running parallel to one another, or a conveyor wheel. The conveyor wheel and the conveyor belts, as the case may be, are provided with separating walls which divide a conveyor path into chambers.

### FIELD OF THE INVENTION

The invention relates to a method and to a device for producing an individual consumer quantity of a ready-to-drink beverage, according to the introductory parts of the independent claims, in particular for manufacturing ready-to-consume hot coffee or tea.

### BACKGROUND OF THE INVENTION

Coffee which was made for the first time in the Orient by way of brewing roasted and ground coffee beans, since its discovery has marched throughout the world with incredible success.

Coffee is an extract of the roasted coffee bean. The extract comprises water-soluble components and solid matter components, and in particular in the modern espresso also oils and fats from the coffee bean, which are emulsified in water. All these substances together determine the taste and the aroma of the coffee. About 25 percent by volume of the ground coffee material goes into the cup of coffee by way of this extraction. The coffee ground on the other hand is undesirable in the cup of coffee. Rather, for avoiding a negative development of aroma and for avoiding very high components of caffeine, one strives for a very rapid separation of the coffee grounds from the extract.

Essentially, three ways of preparation of coffee free of coffee grounds have developed:
according to a first preparation type, the ground material is brewed in water and the extract is driven by way of gravity through the filter and the sieve, and thus the coffee grounds are separated from the beverage. This line nowadays exists with the production of so-called filter coffee. The coffee quality here is dependent particularly on the brewing time (with filter coffee, dependent amongst other things on the permeability of the filter and the fineness of the ground material) and the heat of the water.
according to a second preparation type, the water is driven through the ground material by way of a low vapor pressure. The percolator is a representative of this line. This method results in a tart coffee, since the water must be overheated, in order to develop the necessary vapor pressure.
according to a third preparation type, the water is driven through the ground material by way of mechanical pressure means. This permits the pressure and the temperature of the water to be regulated independently of one another, A so-called espresso is produced with this method. Thereby, pressures of more than 18 bar are mustered. Amongst others, the coveted foam, the so-called “crema”, is typical of the espresso.

Electrically heated coffee machines arrived with the electrical supply at the end of the 19th century, with an electrical pump for building up the pressure in the water at the beginning of the 20th century. The manufacturing methods for coffee free of coffee grounds with the known coffee machines however to this day, may be divided up into the three preparation types specified above.

Practically all coffee machines, independently of the respective preparation type, function according to a batch method. This means that a selected quantity of ground coffee is taken, and an adapted quantity of water is added to this total quantity of ground material, or is driven through the ground material. For this reason, the consumption quantity of the coffee to be produced is already selected with the selection of the coffee quantity and the water quantity proportional thereto. After producing this quantity of coffee, one must start again from the beginning, as soon as more coffee is desired. Such batch methods are sequential, i.e. in each case a sequence of steps are successively run through with a defined quantity. The method may only be interrupted after the completion of each sequence. A continuous production of coffee is not therefore possible with such a method.

Common to all methods is also the fact that the extraction conditions hardly change during the extraction of the ground material. The occurring changes are merely caused by the fact that the ground material has less volume and less content with an advancing extraction. The extraction conditions however, such as pressure, water temperature, water-exposure time etc. are different with different preparation types. For this reasons, different components of the coffee ground material are extracted, depending on the preparation type. For this reason, the coffee produced with the different preparation types have their special characteristics. Various coffee varieties and roasting are particularly suitable for the individual preparation types.

A coffee machine is known from U.S. Pat. No. 4,134,332, with which real coffee may be manufactured in a continuous method in a selectable number of cups. This automatic drinks maker is provided for the continuous brewing of a beverage in any, settable quantity. The maker comprises means for the supply of a mixing tube with a granulated beverage ingredient, such as ground coffee, and hot water. The mixture of water and ground ingredient is led through the mixing tube for a time which is sufficiently long for the brewing. An advance of the mixture is effected thanks to gravity. A moved filter crosses the mixing tube, so that the mixture falling out of the mixing tube continuously reaches a fresh filter region and thus an effective filtering is achieved. The filter consists of a continuously moved endless filter belt. Whilst the beverage flows through the mixing channel, it is held at a suitable constant temperature, since the mixing tube is led through a hot water container.

The duration of an addition of water and granulated beverage ingredient to the mixing tube may be controlled with a time switch clock. A cup number is preselected in this manner. The filter belt also runs during the set time. The water and granulate run through the mixing tube for a certain time. The consumed granulate falls onto the filter belt and is transported away. The beverage passes through the filter belt, is collected thereunder in a funnel and is led into a cup.

The disadvantage of this coffee machine is the fact that a considerable portion of the ground coffee remains exposed to water, and heated in the mixing tube, until the next portion of coffee has left the maker. This portion is extracted much longer than is desired. A constant quality of the beverage is not achieved on account of this.

The specific design of the coffee machine also causes coffee which is held back to drip out of the mixing tube for a certain time due to capillary effects, after the completion of the addition of water to the mixing tube. The coffee production according to this continuous method has remained practically unknown.

The sequential batch method for the manufacture of infinite quantities of ready-to-drink coffee has economically proven itself. For many coffee machines, whether for the household or for the restaurant business, the quantities of coffee required in each case for an individual portion are already sold in a portioned manner. The individual portions are e.g. packed into individual aluminum containers or filter pads. The causes the temporal and spatial separation of the grinding process from the coffee production from the ground coffee.

In any case, with conventional coffee machines, always a roughly equally large quantity is to be added into a filter insert. A cup of coffee is obtained from this constantly equally large portion with water. If a large cup of coffee is let out of the coffee machine, then the same quantity of coffee is used as for a small cup of coffee. Only the water quantity is changed. The type of coffee is therefore very different, depending on the size of the cup.

With filter coffee machines, the quantity of coffee and water may be selected. The quantity is selected according to the consumption quantity to be produced. The quantities required for the desired number of cups are measured and added to the machine. The machine heats the water and drips this over the coffee granulate. Here too, the coffee quality changes depending of the quantity of coffee, since the ground material is extracted longer with larger quantities.

The disadvantage with these known preparation types is the fact that the quantity of ground material and water needs to be selected according to the end quantity before the production of the coffee. It is also disadvantageous that the extraction quality may only be influenced in a modest manner, since certain parameters may not be influenced.

### SUMMARY OF THE INVENTION

It is the object of the invention, to provide a method and a device for manufacturing a ready-to-drink beverage. The beverage should be produced by way of extraction from an aroma carrier by way of water. The method should be able to be effected in a continuous manner. The method should in particular also be able to be interrupted and continued at any time, without the beverage quality suffering on account of this. The beverage quality should also be practically independent of the quantity of the beverage to be produced and of the time duration which has passed since the last production of a beverage. Furthermore, the method with the extraction of coffee, should permit the caffeine content to be kept low, and the aroma content to be kept high.

According to the invention, this object is achieved by a production method according to claim 1.

With such a method for the manufacture of an individual consumption quantity of a ready-to-drink beverage by way of extraction of a solid-matter aroma carrier by way of water, as with the coffee machine according to U.S. Pat. No. 4,134,332, the aroma carrier is moved through the extraction region, and the aroma carrier moving through the extraction regions is permeated by water, wherein the water absorbs aroma substances from the aroma carrier. The aroma carrier is subsequently separated from the extract.

However, for achieving the set object, in contrast to the known method, the aroma carrier during its extraction is forcibly conveyed through the extraction region with a conveyer device. This for example permits the design of the form of the extraction region, the creation of different pressure conditions at different locations of the extraction region, the retention of the differently high water pressures at different locations of the extraction region, the setting of different temperatures at different locations of the extraction region, and the possibility at all of being able to press the water by pressure through the aroma carrier present in the extraction region.

If the water is pressed through the aroma carrier with pressure, this permits the contact time between the water and the aroma carrier, as well as the water quantity which is in contact with the aroma carrier, to be considerably reduced and to be regulated by way of the pressure and the forced conveying. This also permits a granulation of the aroma carrier to be kept very fine, since the water is not driven through the aroma carrier by gravity, but with pressure, so that the capillary forces even of a very finely granulated aroma carrier may be easily overcome. The fine grained structure of the aroma carrier however in turn has a positive effect of the yield of the beverage from the aroma carrier, since a larger volume share of the aroma carrier grains may be extracted in a shorter time, and the aromas may be extracted from a larger volume share of each grain.

The aroma carrier is advantageous subjected to different pressure conditions at different locations of the extraction region. Different fractions of the extract which may be extracted from the aroma carrier may be extracted in a targeted manner by way of this.

Advantageously, the aroma carrier is also subjected to different temperatures at different locations of the extraction region. With this, one may regulate the extraction of individual fractions of the extract with regard to quantity share.

It is furthermore useful to add water and/or to remove water to and/or from the aroma carrier at different locations of the extraction region. The full aroma of different coffee preparation types, such as filter coffee and espresso coffee may be combined by way of this.

If with the previous preparation types, only a certain extraction type could be carried out, the method according to the invention has the advantage that the extraction may encompass more than one extraction type. It therefore encompasses at least two of the mentioned extraction steps:
a. dissolving water-soluble substances in water,
b. flushing fine particles out of the aroma carrier,
c. pressing oils out of the aroma carrier.

Advantageously, at least two of the subsequently mentioned method steps are run through for the extraction:
a. subjecting the aroma carrier to water, and practically pressure-less separation of the water from the aroma carrier
b. flowing water through the aroma carrier at a dynamic hydraulic pressure of at least 10 bar,
c. impinging the aroma carrier with pressure, and pressing water out of the aroma carrier,
d. pressing dry the aroma carrier at a pressure of more than 20 bar.

Each of these method steps releases different fractions of the extractable extract. The share of the aroma substances extracted by the steps may be regulated by way of a quantitative limitation of the individual method steps. The pressure may not only increase in a successive manner, but also phases of the pressure relief, of the vacuum and of the pressure change in the method may be provided. One must also differentiate between impinging the aroma carrier with water pressure or with bodily pressure. By way of the bodily pressure, in particular by way of reduction of the volume of the space around the aroma carrier, one may press oily and fatty shares of the aroma carrier out of this, with or without water.

Advantageously, the aroma carrier which is sufficient for a consumption quantity, is spread out as a layer. Then, a plurality of part regions of the layer are extracted one after the other, for the production of an individual consumption quantity. This permits a continuous manufacturing method of the beverage. Furthermore, a part quantity, or the quantity of aroma carrier which is subjected to the extraction in each case at a certain point in time, may be very low.

Usefully, the aroma carrier is conveyed in a layer along a guide path through the extraction region. The layer may be subdivided or uninterrupted. It usefully covers the guide path on the whole length. In each case, only a part region of the layer may lie in the extraction region, and be extracted there. The duration in which the method is carried out may be increased in an infinite manner, and thus the extract quantity may be infinitely increased. The extraction process may be ended at any time. By way of this, the extraction quantity may be selected in an infinite manner during the extraction process.

Alternatively to the conveying of the aroma carrier as a layer, the aroma carrier may also be conveyed through the extraction region in the form of spatially separated portions in a temporally separated manner. This results in a sensitive graduation of the extraction quantities.

Advantageously, the quantity of aroma carrier which lies in the extraction region is very small in comparison to the quantity of aroma carrier which is necessary for the production of a consumption quantity of the beverage. Approx. 5 to 12 grams of coffee beans are used up to now for producing a consumption quantity of 15 centiliters of a very strong coffee, up to 200 centiliters of a rather watery coffee. For this reason, advantageously less than 5 grams, preferably less than 2 grams, particularly preferably less than 1 gram of coffee ground material is present in the extraction region at any time.

In one embodiment of the method, the layer is divided into small portions bordering one another. The small portions are conveyed in an uninterrupted row. This permits any number of small portions to be extracted, and the method to be stopped after each small portion, or during the extraction of a small portion. If the method is interrupted only after completion of an extraction of a small portion, then it is the case that the smaller are the small portions, the smaller are the selectable extraction quantity differences. If the small portions are very small, a small portion may also only be partly extracted, without a large loss or a noticeable quality reduction of the beverage being effected. The already partly extracted small portion may be then be extracted to the end, at the beginning of the next beverage production, without the quality of the during noticeably suffering. The share of aroma carrier which is subjected to water for longer, and water which has been longer in contact with the aroma carrier, may be neglected in comparison to the total quantity of the extract.

Advantageously, each small position contains a fraction of a quantity of the aroma carrier required for the individual consumption quantity. An individual consumption quantity thereby is a cup, e.g. an espresso cup or a milk-coffee cup, which is designed having a different volume depending on the beverage to be dispensed therein. The small portion advantageously contains at the most a third of the quantity of the aroma carrier required for a consumption quantity, particularly preferably less than a fifth.

The aroma carrier may be conveyed along the guide path in a continuous or intermittent manner. The water may also be supplied continuously or in an intermittent manner. A continuous movement is preferred since this lessens the burden e.g. on the drive and interruption means, such as valves. The intermittent conveying may however also likewise have advantages which is accepted with an increased usage of the device.

The water is advantageously led laterally into the layer with respect to the conveyor direction of the layer, and again laterally out of the layer. The flow direction of the water may accompany the layer over a certain distance, or also be against the conveyor direction of the layer. The flow direction of the water is advantageously selected such that the water flows transversely to the conveyor direction of the aroma carrier through the layer of the aroma carrier.

Simultaneously, usefully, at the most three, preferably at the most two small portions are permeated by water. Usefully in each case a practically waterproof sealed location is formed between two small portions, in order to be able to keep the adjacent small portions dry before the exaction.

The aroma carrier is advantageously compressed during the conveying of the aroma carrier. Such a compression may be useful twice; a first time before the extraction, in order to prepare the aroma carrier for the extraction, and where appropriate, to provide a sealed location with the compressed aroma carrier, and a second time after the extraction, in order to press the residual water quantity collected in and between the aroma carrier out of the aroma carrier. The compression may also have an influence on the aroma content of the extract.

A device for manufacturing a ready-to-drink beverage by way of extracting treatment of a solid-matter-like aroma carrier by way of water, just as with the device according to U.S. Pat. No. 4,1134,332, comprises an extraction region for receiving an aroma carrier, and a supply channel for the aroma carrier. This extraction region lies on the conveyor path between a supply conduit for the water which runs into the extraction region, and a sieve/filter device connecting to the extraction region, with which the aroma carrier may be separated from water containing aroma substances.

Furthermore, the device according to the invention however has a mechanical conveyor device, in order to forcibly convey the aroma carrier through the extraction region, and as the case may be, a device in order to press the water with pressure through the extraction region. The extraction region according to the invention is dimensioned in a manner such that therein and at any point in time, only a fraction of the quantity of aroma carrier which is required for a single consumption quantity, may be present. The advantages of this device lie in the fact that the aspects of the set object with regard to method technology may be achieved with it, which has already been described in detail.

The device usefully has a guide path on which the extraction region is formed, and in which the aroma carrier may be present and may be conveyed through the extraction region. This guide path, as the case may be, permits the forced conveying of grained granulate which lies on the guide path in a loose manner. Usefully, for this, the conveyor device comprises separating walls which subdivide the guide path into chambers.

The chambers have a volume which advantageously provides space, at the most for only a fraction of a quantity of aroma carrier required for producing a consumption quantity of the beverage. Due to this, several chambers must run through the extraction region, in order to produce a consumption quantity of the beverage. The advantages of this are: low losses in quantity with only a partial extraction of the contents of a chamber, and by way of this the possibility of interrupting the extraction process at any point in time.

The conveyor device may be designed for a continuous or intermittent conveying of the aroma carrier.

Usefully, the supply conduit runs laterally into the guide path, and the sieve/filer device is arranged laterally on the guide path. This permits a throughput distance to be able to be designed in a very short manner, despite a large longitudinal extension of the guide path.

Usefully, the run-in of the supply conduit has an extension in the conveyor direction of the aroma carrier, which is shorter than double the length of the chamber, preferably even shorter than a single length of the chamber. The sieve/filter device advantageously in each case delimits at least that chamber into which the supply conduit runs.

Advantageously, a sealed location on the guide path lies upstream of the run-in of the supply conduit. This location separates a dry region of the aroma carrier from a wet region of the aroma carrier. A second sealed location downstream of the first sealed location offers the advantage that the extraction may be carried out under high pressure between the two sealed locations.

In order to seal the chambers to one another in a largely waterproof manner before and after the extraction region, the conveyor device usefully comprises chamber walls between which chamber walls chambers are formed within the guide path.

The guide path advantageously has a location which is narrowed in cross section perpendicular to the longitudinal direction of the guide path. An aroma carrier is compressed on passage through this location. This compression may be used for the formation of a sealed location, or however only as a preparation of the aroma carrier for its extraction, and for pressing out the residual water remaining in the aroma carrier.

In one embodiment of a device according to the invention, a guide path is formed between a spiral of a transport worm, or several guide paths are formed between several spirals of a transport worm. This transport worm may be in engagement with a second worm for forming a plurality of chambers. The chambers formed in this manner displace in the axial direction of the worms on rotation of the worms. One worm may also be in engagement with a toothed crawler, so that in each case one spiral of the worm forms a chamber, which at the front and at the rear is closed by two teeth of the toothed crawler which follow one another.

A sealed location on the transport worm may however also be formed with a toothed wheel, said toothed wheel being in engagement with the spiral of the transport worm.

A sealed location may also be formed by a narrowing of the cross section of the guide path, wherein the narrowing is dimensioned in a manner such that the granulate at the sealed location is greatly compressed in a manner such that the guide path is practically sealed off by way of the compressed granulate.

The guide path in a second embodiment example may also be formed by a channel running in a straight line or in an arcuate manner. The conveyor device comprises chamber walls which subdivide this channel into a plurality of chambers. These chamber walls are displaceably arranged in the channel with a drive.

The channel walls thereby are usefully formed on an elastic belt which is guided in an endless loop.

Also two elastic belts may be provided with chamber walls, and the belts may be arranged lying opposite one another, so that in a transport region, in each case one chamber wall of the one belt contacts a chamber wall of the other belt. The advance of the two belts is usefully coupled to one another.

According to a third embodiment example, the conveyor device is rotatable about an axis and comprises radial chamber walls. The chamber walls are advantageously movable in the radial direction.

### BRIEF DESCRIPTION OF THE DRAWINGS

The invention is hereinafter explained by way of a selection of embodiment examples. There are shown schematically in:

FIG. 1 a device for carrying out the method according to the invention,

FIG. 2 a view of a conveyor device with two cooperating belts,

FIG. 3 a perspective sketch of a conveyor device with two belts according to FIG. 2,

FIG. 4 a perspective sketch of a conveyor device with a single belt,

FIG. 5 a perspective sketch of a conveyor worm with a toothed crawler,

FIG. 6 a view of the conveyor worm according to FIG. 5 with a housing represented sectioned,

FIG. 7 two conveyor worms meshing one another,

FIG. 8 a conveyor worm with a toothed wheel in engagement with its spiral,

FIG. 9. a conveyor worm with a compacting cone in front of an extraction region,

FIG. 10 a conveyor worm in each case with a compacting cone before and after the extraction region,

FIG. 11 a conveyor worm with a compacting cone after the extraction region,

FIG. 12 a partly sectioned view of a conveyor worm which is combined with a grinder,

FIG. 13 a perspective representation of the conveyor worm according to FIG. 12,

FIG. 14 a perspective representation of a conveyor spiral,

FIG. 15 perceptively, a conveyor wheel with radially movable chamber walls,

FIG. 16 a view of the conveyor wheel according to FIG. 15.

### DETAILED DESCRIPTION

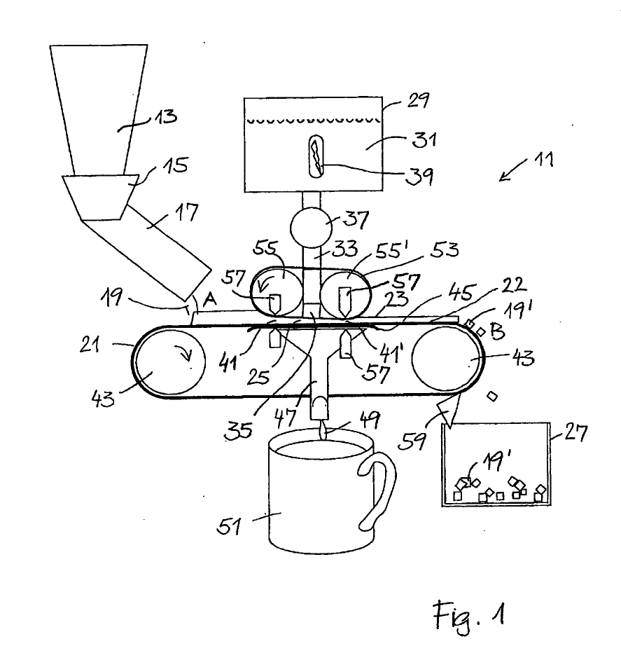

The schematic drawing of a coffee machine 11 represented in FIG. 1 shows a bean container 12 with a grinder 15 connecting thereto. Connecting to the grinder is a supply device 17, in order to lead the ground material 19 onto a ground material carrier 21. The ground material carrier forms a conveyor path 22. A layer 23 of the ground material 19 is spread on the ground material carrier 21. The fresh ground material 19 is an aroma carrier. The aroma of the ground material 19 is extracted from the ground material 19 in an extraction region 25. The layer 23 behind the extraction region 25 contains spent ground material 19′ whose aroma (water-soluble substances, solid matter, oils and fats) have been essentially extracted. This spent ground material 19′ gets into a waste container 27.

The schematic drawing of FIG. 1 further shows a water container 29 and in this, water 31. A water supply conduit 33 is connected to the water container 29. This conduit runs into the extraction region 25 at a location 35. A pressure pump 37 is incorporated into the water supply conduit. The water 31 at the opening into the extraction region is usefully at 97° C. A heating element 39 is arranged in the water container 29 for heating the water 31 to this temperature. The heating element 39 may also be incorporated into the water supply conduit 33.

The extraction region 25 is formed between two sealed locations 41. The ground material carrier 21 is an endless belt which is guided around two rollers 43 and through the extraction region 25. The endless belt is water permeable. The endless belt is supported along the extraction region 25 by a filter plate 45. A funnel 47 for collecting the extract is arranged below the filter plate 45. This funnel 47 leads the coffee 49 into a cup 51.

In order for water 31 in the extraction region 25 to be able to be pressed through the layer 23 with pressure, the layer 23 in this region is held between the endless belt of the ground material carrier 21 and a second endless belt, the compression belt 53. The compression belt 53 is tensioned around two compression rollers 55, 55. The compression rollers 55, 55′ are pressed against the filter plate 45. The arrows 57 represent the pressure with which the compression rollers 55, 55′ compress the layer 23. The first compression roller 55 in the conveyor direction (from the left to the right, from A to B) is pressed against the filter plate 45 to a lesser extent than the second compression roller 55′. The compression belt 53, differently to the representation, in the region between the compression rollers 55, 55′, may comprise a region in which the compression of the layer is less than at the compression rollers 55, 55′. The layer 23 is therefore compressed to a different extent at different locations of the extraction region 25.

The water pressure lies at least 7 or 10×10⁵ Pa. A water pressure of up to 25 or even 30×10⁵ Pa may also be built up with the pressure pump 37. The pressure at the sealed locations 41 lies above the dynamic pressure of the water 31 at these locations. The dynamic water pressure at the sealed locations 41 lies at approx 7×10⁵ Pa. The first compression roller 55 presses with 10×10⁵ Pa, and the second compression roller 55′ at 30×10⁵ Pa.

Coffee is made with device in the following manner: Coffee beans get from the bean container 13 into the grinder 15 and in this, are ground into a fine powder. This aroma carrier 19 now goes through the supply device 17 onto the ground material carrier 21. A layer 23 is formed with the ground material 19 on the ground material carrier 21. This layer 23 is then conveyed along a conveyor route from A to B from the left to the right. The forced conveying has the effect that the ground material 19 gets between the compression belt 53 and the ground material carrier 21 into an extraction region 25. The ground material 19 is compressed between the compression belt 53 and the ground material carrier 21. The compression is increasing.

Hot water 31 is pressed into this extraction region 25 with pressure. This water partly escapes into a layer region which is compressed to a lesser extent, partly penetrates the layer 23 on the direct path, and gets through the pores of the ground material carrier 21 and the openings of the filter plate arranged thereunder, into the funnel 47. The water 31 which is pressed through in a direct manner thereby carries with it those components of aroma substances which are usually extracted for an espresso coffee. The water which moves out counter to the conveyor directions lies in the aroma carrier somewhat longer, softens this and absorbs aroma substances which are usually extracted with the production of filter coffee. This water is partly pressed out by the compression which increases with the progressive conveying, is partly conveyed further, and entrained by water flowing directly through. Water remaining back in the aroma carrier is practically completely pressed out of the aroma carrier 19 by way of the compression which increases with the progressive conveying.

However, yet a further extraction step is carried out by way of the high compression pressure of the second compression roller 55′. By way of the compression of the aroma carrier 19, oil and fat is also pressed out of the aroma carrier 19, which likewise penetrates through the carrier belt 21 and gets into the funnel 47. The extract from the coffee powder 19 for this reason contains different fractions, which are extracted from the aroma carrier 19 thanks to the parameter values of different parameters, which change along the conveyer path. The values of the parameter of compression increases along the conveyor route in a more or less continuous manner, the value of the parameter of water exposure time is shorter for the water pressed directly through the layer 23 than for the water which moves out. The parameter of water temperature is practically unchanged. The value of the parameter of dynamic water pressure is initially lower, thereafter increases, in order to subsequently reduce again.

The extract 49, with regard to the conveyor direction, is driven laterally out of the aroma carrier 19. It exits the layer 23 over the whole length of the exaction region 25, and goes through the funnel 47 into the cup 51. The extracted aroma carrier 19′ gets into the waste container 27. Aroma carrier 19′ which sticks to the carrier belt 21 is removed by a scraper 59.

Any quantity of coffee in a constant quality may be produced thanks to the continuous manufacture of the beverage. The aroma carrier 19 present in the extraction region 25 weights about two grams. A threefold or quadruple amount of aroma carrier present in the extraction region is required for a cup of coffee. If the method is interrupted, less than a twentieth of the water quantity required for a cup remains in the aroma carrier, and is not pressed out until with the next cup. This share may however be neglected for the quality of the beverage.

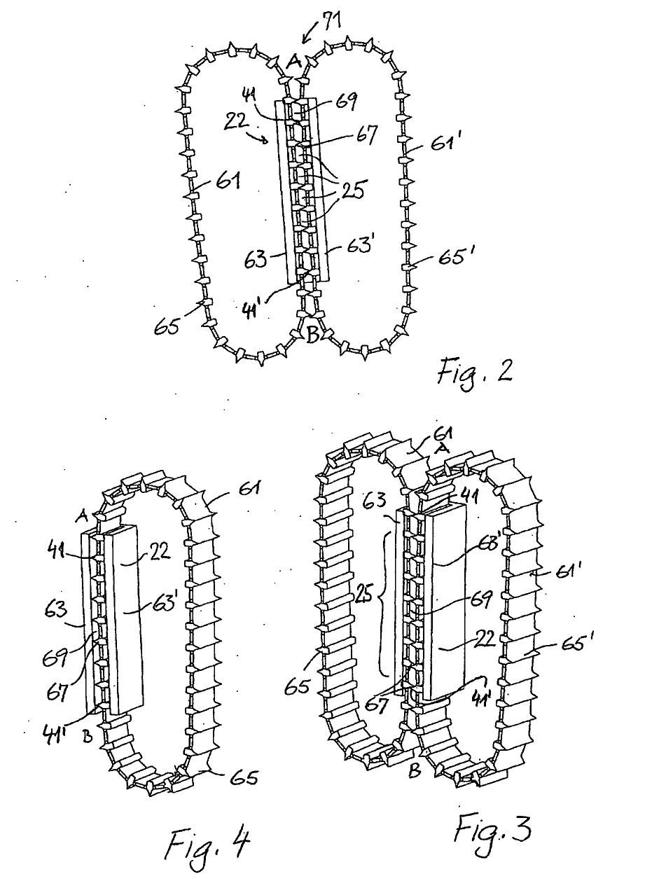

FIGS. 2 to 16 show different embodiment examples of conveyer devices for such a device. In the FIGS. 2 and 3, two belts 61, 61′ running with one another in an extraction region 25 are shown. These belts 61, 61′ run through and between two plates 63, 63′ and in an endless manner in each case around two deflection wheels which are not represented. The extraction region 25 is formed between the plates. The plates and the belts together form a conveyor route 22 along which the aroma carrier covers a conveyor route from A to B.

The belts 61, 61′ are provided with a multitude of separating walls 65, 65′. These separating walls 65, 65′ are arranged at regular distances on the belts 61, 61′. The separating walls 65 of the one belt 61 and the separating walls 65′ of the other belt 61′ may cooperate and are arranged opposite one another. Cooperating separating walls 65, 65′ form a chamber wall 67 between two chambers 69 which are separated by this chamber wall. A series of chambers 69 is formed between the plates 63, 63′. The plates 63, 63′ approach one another in the advance direction. By way of this, the chambers 68 become smaller, the further they are advanced between the plates on the conveyor route in the direction B.

These chambers 69 open in the advance direction after the extraction region 25, so that the contents may be removed from the chambers 69. The belts 61, 61′ approach one another in front of the extraction region 25 in the advance direction, and the chamber walls 68 are formed by two contacting separating walls 65, 65′. In this region 71, on operation of the device, an aroma carrier is filled into the closing chambers 69.

In the extraction region 25, water 31 flows through the filled-in aroma carrier 19. This may for example be effected in a direction transversely to the conveyor direction and parallel to the plates 63, 63′. For this, at least in each case one chamber in the extraction region must be laterally delimited by a sieve/filter device. The water together with the aroma carrier may be filled into the chamber 69 in a pressure-less manner, and be pressed out of this by way of the compression of the aroma carrier present in the chamber 69. It may also be pressed through the layer 23 of the aroma carrier 19 present in the chambers 69, by way of pressure.

A conveyor device with only one such belt is represented in FIG. 4. The belt runs through the extraction region 25 between the two plates 63, 63′ from A to B. A compression of the aroma carrier 19 may only be carried out to a limited extent, since each chamber wall only needs to be formed by a single separating wall 65. The degree of the compression is limited by the elasticity of the separating wall.

Conveyor worms are represented in the FIGS. 5 to 13. These conveyor worms 73 each have a spiral 75. A helical space 77 which serves as a conveyor path 22, lies between the spiral 75, so that the aroma carrier along the conveyor path 22, covers a conveyor route from A to B. In each case there may also be two spirals, between which two helical spaces lie. This space 77 and the spiral 75 are wound around a core 79. The intrinsic nature of such conveyor worms is that the pressure in the mass conveyed with the conveyor worm is able to greatly increase towards the end of the conveyor distance. A narrowed outlet opening (e.g. at B in FIG. 6) is sufficient, in order to permit the pressure to increase in the helical space 77 during operation of the conveyor worm 73. Additionally, by way of a tapering of the cross section of the helical space 77, one may achieve a pressure increase in the conveyed material and a compression of the conveyed material 19.

Such a conveyor worm 73 is therefore a suitable means for conveying the aroma carrier 19 through the extraction region 25 of a device according to the invention. An addition of water 31 to the aroma carrier 19 may be effected from a hollow core 79, through a perforated wall of the core. The sieve/filter device may at least partially form a cylindrical tube body 80 (FIGS. 6, 12 and 13) in which the conveyor worm 73 is rotatably arranged.

There are different possibilities of subdividing the helical space 77 of such a conveyor worm 73 into discrete chambers. A first manner of subdividing is shown in the FIGS. 5 and 6. Here, the subdivision is effected with a crawler 81 which is in engagement with the spiral 75 of the conveyor worm 73. This crawler 81 subdivides the helical space 77 into individual windings of 360 degrees. Each winding forms a chamber which is sealed off with respect to adjacent windings. The contents of each chamber are conveyed with each revolution of the conveyor worm 73 about a pitch of the spiral 75.

With such a conveyor worm, on operation, the tube wall, i.e. also the sieve/filter device is cleaned by the spiral 75, the spiral and the core 790 are cleaned by the crawler 81, and the crawler 81 is cleaned by the spiral 75 and by a guide 82 for the crawler 81.

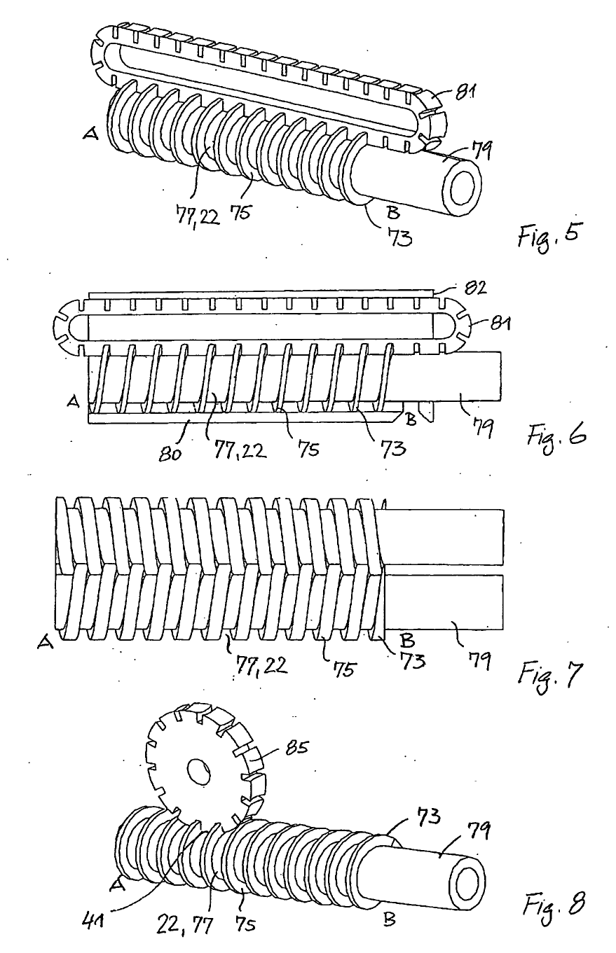

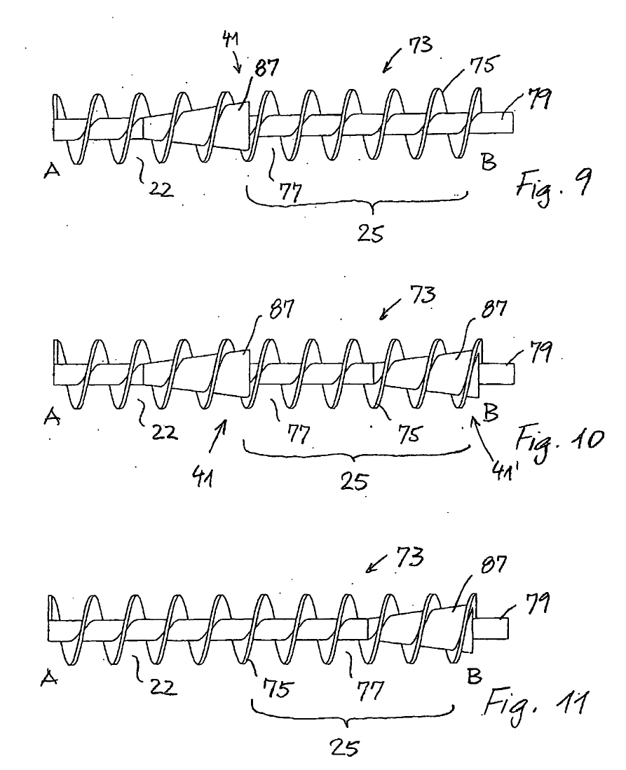

The double worm 73, 83 shown in FIG. 7 forms a further possibility of dividing the helical space 77 of a conveyor worm 73 into discrete chambers. The two worms with their spirals engage into the helical space of the adjacent worm and subdivide this by way of this.

A third possibility of subdividing this space 77 is provided by a toothed wheel 85. The toothed wheel 85 engages between the spiral 75 and thus closes off the helical space at one location. A very high pressure may be built up during the forced conveying of the aroma carrier 19 in the helical space 77 by way of this. A suitable cross-sectional shape of the spiral 75 permits the space 77 to be able to be sealingly closed to a reasonable extent.

Conveyor worms 73 with a core 79 are represented in the FIGS. 9 to 11, said cores in each case being widened on at least one location into a compacting cone 87. Each compacting cone 87 reduces the cross section of the helical space 77 between the core 79, the spiral 75 and a tube wall which is not shown in the figures. A conveyed aroma carrier may be compacted by way of this. Extract contained in it may be pressed out.

Such a compacting may, as in FIGS. 9 and 10, be present in front of an extraction region 25, in order to create a sealed location 41. This sealed location prevents the aroma carrier 19 from being subjected to water before the sealed location. This compacting may also press aroma substances already contained in the aroma carrier 19, in particular fats and oils, out of the aroma carrier. These may be extracted in a simpler and quicker manner by way of this.

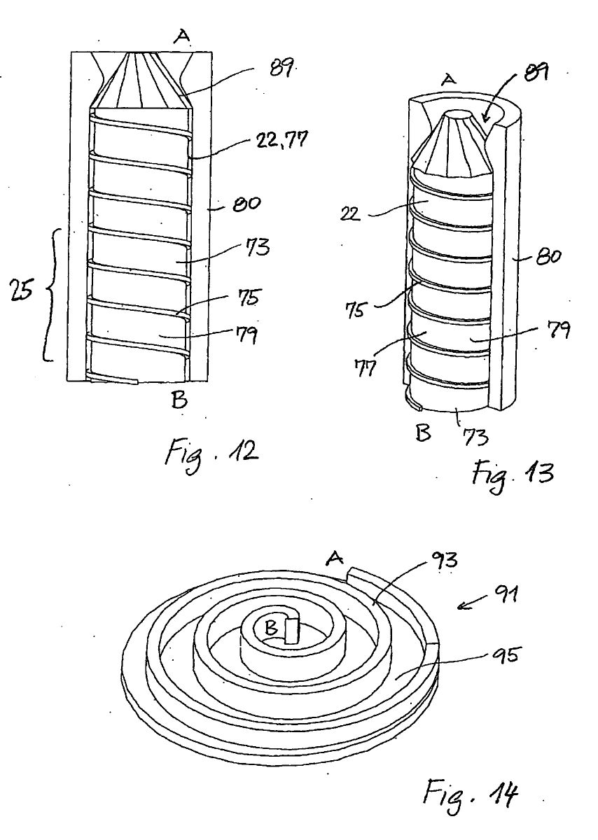

Such a compacting may also be useful after the extraction region 25, as shown in FIGS. 10 and 11, in order to press extract out of the aroma carrier 19. Fats and oils may be pressed out of the aroma carrier at this location too. The figures also show that a compacting may be present at several locations.

A grinder 89 is arranged upstream of the conveyor worm 73 in FIGS. 12 and 13. The grinder serves for the size reduction of the coffee beans and therefore for leading the ground material to the extraction region 25 in an extremely fresh manner. The ground material gets immediately onto the conveyor path 22, formed by the helical space 77 of the conveyor worm 73. This space at least partially forms the extraction region 25.

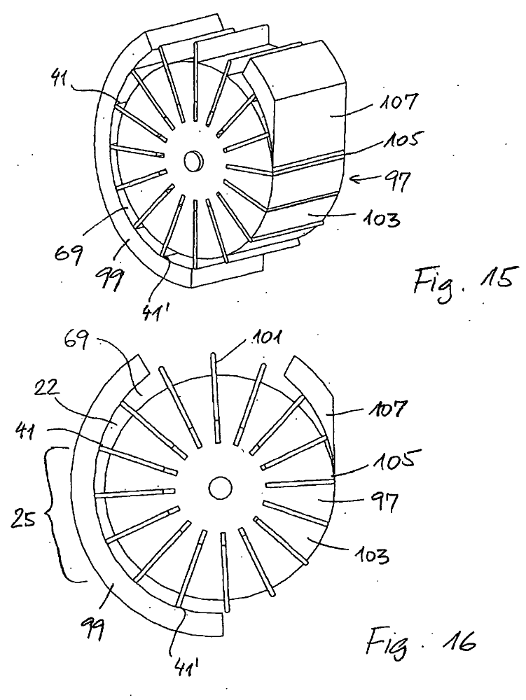

The conveyor spiral 91 represented in FIG. 14 is advantageously operated from the outside to the inside, thus rotating in the anticlockwise direction. The spiral-shaped wall 93 defines a spiral-shaped conveyor path 95 on which the aroma carrier is conveyed from A to B. At least two pegs (not represented) which are guided in a radial displaceable manner, may reach into the conveyor path 95 and seal this between the wall 93, in order in this manner to form a chamber between the pegs. On rotating the conveyor spiral, the pegs are pushed to the center (B). This chamber is very greatly reduced in volume, the further the peg is advanced towards the center of the conveyor spiral 91.

A further conveyor device is represented in FIGS. 15 and 16. This consists of a bladed wheel 97 which is arranged in a roughly circular guide 99. The bladed wheel 97 has separating walls 101 which as blades project radially beyond the diameter of an inner wheel body 103. These separating walls 101 are radially displaceable and when they are guided along the guide 99 by way of a rotation of the bladed wheel, are in constant contact with this guide. A series of chambers is formed by the separating walls 101, the inner wheel body 103 and the guide 99, and by way of side closures which are not shown. The guide 99 encloses only a part of the periphery of the bladed wheel 97. The chambers 69 are open at the other locations.

The separating walls 101 during the rotation of the bladed wheel 97 are moved in the radial direction by way of a guide device which is not represented. They are fully retracted into the inner wheel body 103 at a location 105 of the wheel periphery. A wiper 107 is present at this location, which cleans the periphery of the inner wheel body 103.

On operation, an aroma carrier is filled into an open chamber 69. This small quantity of aroma carrier reaches the guide 99 with a progressive rotation of the bladed wheel 97. Since the guide and the bladed wheel do not have the same circular centers, the cross section of the chamber reduces on further rotation of the bladed wheel 97. The aroma carrier is compacted by way of this. A flow of water through the aroma carrier may be effected from the inside to the outside, from the outside to the inside, or parallel to the rotation axis of the bladed wheel. The water may also be led to the chamber without pressure, and by way of the size reduction of its volume be pressed out again through a perforation in the guide 99.

With this device too, it is ensured that the individual surfaces which may become dirty, may be wiped by way of parts moving relative to these, and cleaned by way of this.

On common advantage of all these devices is the fact that they take up relatively little space. This is due to the fact that the necessary quantity of aroma carrier is not extracted once, but in a successive manner.

Concluding, the following is to be mentioned. With a method for producing a ready-to-drink beverage by way of extraction of a solid-matter aroma carrier 19 by way of water, the aroma carrier 19 is successively moved through an extraction region 25. Water 31 passes through the part quantity of the aroma carrier 18 required for an individual consumption quantity, said part quantity being present in each case in the extraction region 25, wherein the water absorbs aroma substances from the aroma carrier, and subsequently the aroma carrier 19 is separated from the extract 49. The method is characterized in that furthermore, the aroma carrier is forcibly conveyed through the extraction region 25 with a conveyor device 21,43,53,55;61;61′,73;91;97. A device for the forced conveying of the aroma carrier 19 for example has a conveyor worm 73, two conveyor belts 61, 61′ running in parallel, or a conveyor wheel 97, 91. The conveyor wheel 97 and the conveyor belts 61, 61′ are provided with separating walls 65, 101, which are displaceably arranged in a conveyor path 22, and subdivide the conveyor path 22 into chambers 69.

1. A method for the production of an individual consumption quantity of a ready-to-drink beverage by way of extraction of a solid-matter aroma carrier by way of water, comprising:
a. supplying the aroma carrier to an extraction region,
b. moving the aroma carrier through the extraction region,
c. extracting the aroma carrier moving through the extraction region with water and
d. separating the aroma carrier from the extract,
e. forcibly conveying the aroma carrier along a conveyor route through the extraction region while the extraction of an individual consumption quantity is being effected.

2. A method according to claim 1, characterised in that further comprising leading the extract along the conveyor route, with respect to the conveyor direction, laterally out of the aroma carrier.

3. A method according to claim 1, further comprising subjecting the aroma carrier to a parameter which determines the extraction and which changes along the conveyor route.

4. A method according to claim 3, further comprising subjecting the aroma carrier to different pressure conditions at different locations of the extraction region.

5. A method according to claim 3, further comprising subjecting the aroma carrier to different temperatures at different locations of the extraction region.

6. A method according to claim 3, further comprising adding water to or taking water from the aroma carrier at different locations of the extraction region.

7. A method according to claim 3, wherein the extracting further comprises at least two of the following steps:
a. dissolving water-soluble substances in water,
b. flushing fine particles out of the aroma carrier, and
c. pressing out oils from the aroma carrier.

8. A method according to claim 3, wherein the extracting further comprises, at least two of the following steps:
a. subjecting the aroma carrier to water, and practically pressure-less separation of the extract from the aroma carrier,
b. impinging the aroma carrier with pressure, and pressing extract out of the aroma carrier,
c. flowing water through the aroma carrier at a dynamic hydraulic pressure of at least 10×10⁵ Pa, and
d. pressing dry the aroma carrier at a pressure of more than 20×10⁵ Pa.

9. A method according to claim 1, further comprising:
a. spreading out the aroma carrier is as a layer, and
b. extracting and the part regions of the layer are successively extracted.

10. A method according to claim 9, further comprising dividing the layer into small quantities, and conveying the small quantities in an uninterrupted row.

11. A method according to claim 10, further comprising providing each small quantity with a fraction of a quantity of the aroma carrier required for an individual consumption quantity.

12. A method according to claim 1, further comprising forming a plurality of discrete small quantities of the aroma carrier is formed, and several small quantities in each case with a corresponding fraction of the envisaged water quantity is extracted in a successive sequence.

13. A method according to claim 12, further comprising selecting the consumption quantity after or during the extraction of a number of small quantities by way of interrupting the method.

14. A method according to claim 1, further comprising driving the water with pressure through the aroma carrier present in the extraction region.

15. A method according to claim 1, characterised in that the aroma carrier is continuously conveyed along the conveyor route through the extraction region.

16. A method according to claim 1, further comprising conveying the aroma carrier along the conveyer route through the extraction region in an intermittent manner.

17. A method according to claim 1, further comprising supplying water, with respect to the conveyor direction of the aroma carrier, along the conveyor route, laterally to the aroma carrier.

18. A method according to claim 17, further comprising flowing the water through the aroma carrier transversely to the conveyor direction of the aroma carrier.

19. A method according to claim 10, further comprising forming a practically water-tight sealed location between two small quantities.

20. A method according to claim 1, further comprising compressing the aroma carrier during the conveying of the aroma carrier along the conveyor route.

21. A device for the production of an individual consumption quantity of a ready-to-drink beverage by way of extraction of a solid-matter aroma carrier by way of water, comprising:
a conveyor path for accommodating an aroma carrier,
a supply channel for the aroma carrier, which runs into the conveyor path,
a supply conduit for the water, which runs into the conveyor path, and
a sieve/filter device, to separate the extracted aroma carrier from the extract,
wherein the conveyor path between the run-in of the supply conduit for water, and the sieve/filter device, forms an extraction region, and
a mechanical conveyor device to forcibly convey the aroma carrier along the conveyor path through the extraction region,
whereby the extraction region is dimensioned in a manner such that at any point in time, only a fraction of a quantity of aroma carrier necessary for production of an individual consumption quantity of the beverage may be present therein.

22. A device according to claim 21, wherein the sieve/filter device is arranged laterally accompanying the conveyor path in the longitudinal direction.

23. A device according to claim 21, wherein the extraction region is designed differently different locations, and, at different locations, a parameter determining the production of the beverage has different values.

24. A device according to the claim 21, further comprising a device to press water with pressure through the extraction region.

25. A device according to claim 21, wherein the conveyor device comprises separating walls which divide the conveyor path into chambers.

26. A device according to claim 25, wherein the chambers have a volume, said volume having space at the most for a fraction of a quantity of aroma carrier required for the production of a consumption quantity of the beverage.

27. A device according to the claim 21, wherein the conveyor device is designed for a continuous conveying of the aroma carrier.

28. A device according to claim 21, wherein the conveyor device is designed for an intermittent conveying of the aroma carrier.

29. A device according to claim 21, wherein the supply conduit runs laterally into the guide path.

30. A device according to claim 29, further comprising a sealed location on the conveyor path, said sealed location with respect to the conveyor direction of the aroma carrier, lying upstream of the run-in of the supply conduit.

31. A device according to claim 30, further comprising a second sealed location downstream of the first sealed location with respect to the conveyor direction of the aroma carrier, between which sealed locations, the supply conduit runs into the conveyor path, and the sieve/filter device is arranged.

32. A device according to claim 31, wherein the conveyor device comprises chamber walls, between which chamber walls chambers are formed within the conveyor path, and that the chamber walls seal the chambers to one another in a largely water-tight manner, at least in front of and after the extraction region.

33. A device according to claim 21, wherein the conveyor path has a location which is narrowed in cross section perpendicular to the longitudinal direction of the conveyor path, and an aroma carrier is compressed on passage through said location.

34. A device according to claim 21, wherein the conveyor path is formed between a spiral of a transport worm, or several conveyor paths are formed between several spirals of a transport worm.

35. A device according to claim 34, further comprising a crawler in multiple engagement with the spiral.

36. A device according to claim 34, wherein the transport worm is in engagement with a second worm, so that the guide path on the first transport worm is divided into a plurality of chambers, which displace in the axial direction of the worms on rotation of the worms.

37. A device according to claim 34, further comprising a sealed location on the transport worm formed with a toothed wheel which is in engagement with the spiral of the transport worm.

38. A device according to claim 21, further comprising a sealed location is formed by a narrowing of the cross section of the guide path, wherein the narrowing is dimensioned in a manner such that the granulate at the sealed location is compressed to such a great extent that the guide path is practically sealed off.

39. A device according to claim 21, wherein the guide path is formed by a channel which runs in a straight line or which runs in an arcuate manner, and the conveyor device comprises chamber walls which subdivide the channel into a plurality of chambers, and the chamber walls are displaceably arranged in the channel with a drive.

40. A device according to claim 39, wherein the chamber walls are formed on an elastic belt which is guided in an endless loop.

41. A device according to claim 40, further comprising two elastic belts with separating walls, the belts arranged lying opposite one another, and in a region of the conveyor path, in each case one separating wall of one belt contacts a separating wall of the other belt, and the two separating walls together form a chamber wall.

42. A device according to claim 41, wherein the belts are coupled to one another so that they move equally rapidly.

43. A device according to claim 21, wherein the conveyor device is rotatable about an axis, and comprises chamber walls standing radially to the axis.

44. A device according to claim 43, wherein the chamber walls are movable in the radial direction.

45. A method for manufacturing a ready-to-drink beverage by extraction of a solid-matter aroma carrier by way of water, comprising:
moving the aroma carrier through an extraction region,
permeating the moving aroma carrier with water, and
separating the aroma carrier from the extract,
forcibly conveying the aroma carrier with a means for conveying through the extraction region, and
driving the water with pressure through the aroma carrier present in the extraction region.

46. A method for the manufacture of an individual consumption quantity of a ready-to-drink beverage by way of extraction of a certain quantity of a solid-matter aroma carrier by way of a certain quantity of water, with which in a temporal sequence, part quantities of the aroma carrier quantity and part quantities of the water quantity are mixed and led through an extraction region, and the extract is separated from the extracted aroma carrier, comprising:
dividing the aroma carrier quantity for an individual consumption quantity is into a plurality of small quantities,
extracting one after the other, several small quantities in each case with a corresponding fraction of the envisaged water quantity, and
selecting the individual consumption quantity by way of interrupting the method after the extraction of the plurality of small quantities.

47. A method for the manufacture of an individual consumption quantity of a ready-to-drink beverage by way of extraction of a portion of solid-matter aroma carrier by way of a certain water quantity, comprising:
spreading out as a layer an aroma carrier quantity sufficient for an individual consumption quantity and;
flowing water flows through several part quantities of the aroma carrier quantity sufficient for only a single consumption quantity, as part regions of the layer, one after the other.
